(19) United States
(12) Patent Application Publication
(10) Pub. No.: US 2008/0072222 A1
(43) Pub. Date: Mar. 20, 2008

(54) Client outsourcing service

(75) Inventors: David Frederick Bantz, Portland, ME (US); Ramon Caceres, New York, NY (US); Kenneth M. Wei, Hastings on Hudson, NY (US)

Correspondence Address: DUKE W. YEE, YEE & ASSOCIATES, P.C., P.O. BOX 802333, DALLAS, TX, 75380, US

(73) Assignee: International Business Machines Corporation, Armonk, NY (US)

(21) Appl. No.: 11/513,468

(22) Filed: Aug. 31, 2006

(51) Int. Cl. G06F 9/455

(52) U.S. Cl. 718/1

(57) ABSTRACT

A computer implemented method, apparatus, and computer usable program code for managing computers. The computers are deployed on a network for use by users in response to forming a contractual agreement to provide outsourcing management of the computers. The computers include virtual machines. A computing environment of a user is accessible on a first computer using a virtual machine located on the first computer. The virtual machines are maintained on the computers. The virtual machine state may be transferred from the first computer to the second computer. The second computer runs the virtual machine. The computing environment is accessible to the user on the second computer.

### BACKGROUND OF THE INVENTION

1. Field of the Invention

The present invention relates generally to data processing, and more particularly to a computer implemented method, apparatus, and computer usable program code for managing computers.

2. Description of the Related Art

In many businesses, computer users need personalized access to information technology resources at many locations within a campus or office facility. For example, K-12 students need to have access to school information technology resources from any classroom and from certain other areas in the school. Another example, taken from manufacturing, is the need for supervisory personnel to have access to their personal interactive environment or personal computing environment from any workstation on the shop floor. The personal interactive environment or user's environment includes, for example, the setup, configuration, programs, files, personalizations, and details of a user's system as established by the user.

Currently, this need can be satisfied in three ways. First, a person may use a portable computer. When using a portable computer, the user's personal computing environment must be transported from place to place by the user.

Next, the user may use a terminal. When using a terminal, the user's personal computing environment resides on a server and is accessed in client/server mode. Additionally, the user may use a roaming profile. For example, Windows® roaming profiles may be used so that the user's personal computing environment resides on a server and causes a given personal computer to be personalized at the time of use.

Each different method may be problematic, expensive, or undesirable for various reasons. Portable computers are expensive to buy, expensive to own, and compromise usability because of limited screen size, small keyboards, novel cursor control devices, poor sound, and limited system resources. In some cases, the total cost of ownership for portable computers has been cited to be as much as twice that of desktops. Portable computers also require the user to carry the computer and attachments from place to place.

Terminal-based computing, such as network computers and windows terminals, requires constant connectivity to a network and often has poor interactive performance. Windows® roaming profiles are complex to establish and maintain and are not an open solution because they depend on a proprietary implementation. Further, Windows® roaming profiles may cause long delays if the user's applications are not currently installed on the current workstation. As a result, accessing the user's environment may still be difficult or cost prohibitive.

### SUMMARY OF THE INVENTION

The illustrative embodiments provide a computer implemented method, apparatus, and computer usable program code for managing computers. The computers are deployed on a network for use by users in response to forming a contractual agreement to provide outsourcing management of the computers. The computers include virtual machines. A computing environment of a user is accessible on a first computer using a virtual machine located on the first computer. The virtual machines are maintained on the computers. The virtual machine state may be transferred from the first computer to the second computer. The second computer runs the virtual machine. The computing environment is accessible to the user on the second computer.

### BRIEF DESCRIPTION OF THE DRAWINGS

The novel features believed characteristic of the illustrative embodiments are set forth in the appended claims. The illustrative embodiments themselves, however, as well as a preferred mode of use, further objectives, and advantages thereof, will best be understood by reference to the following detailed description of an illustrative embodiment when read in conjunction with the accompanying drawings, wherein:

FIG. 1 is a pictorial representation of a data processing system in accordance with the illustrative embodiments;

FIG. 2 is a block diagram of a data processing system in accordance with the illustrative embodiments;

FIG. 3 is an exemplary infrastructure for client outsourcing services in accordance with the illustrative embodiments;

FIG. 4 is a lifecycle model of a personal computer in accordance with the illustrative embodiments;

FIG. 5 is a flowchart of a process for deploying a new personal computer in accordance with the illustrative embodiments;

FIG. 6 is a flowchart of a process for maintaining a personal computer in accordance with the illustrative embodiments;

FIG. 7 is a flowchart of a process for removing a personal computer in accordance with the illustrative embodiments; and

FIG. 8 is a flowchart for a possible billing process in accordance with the illustrative embodiments.

### DETAILED DESCRIPTION OF THE PREFERRED EMBODIMENT

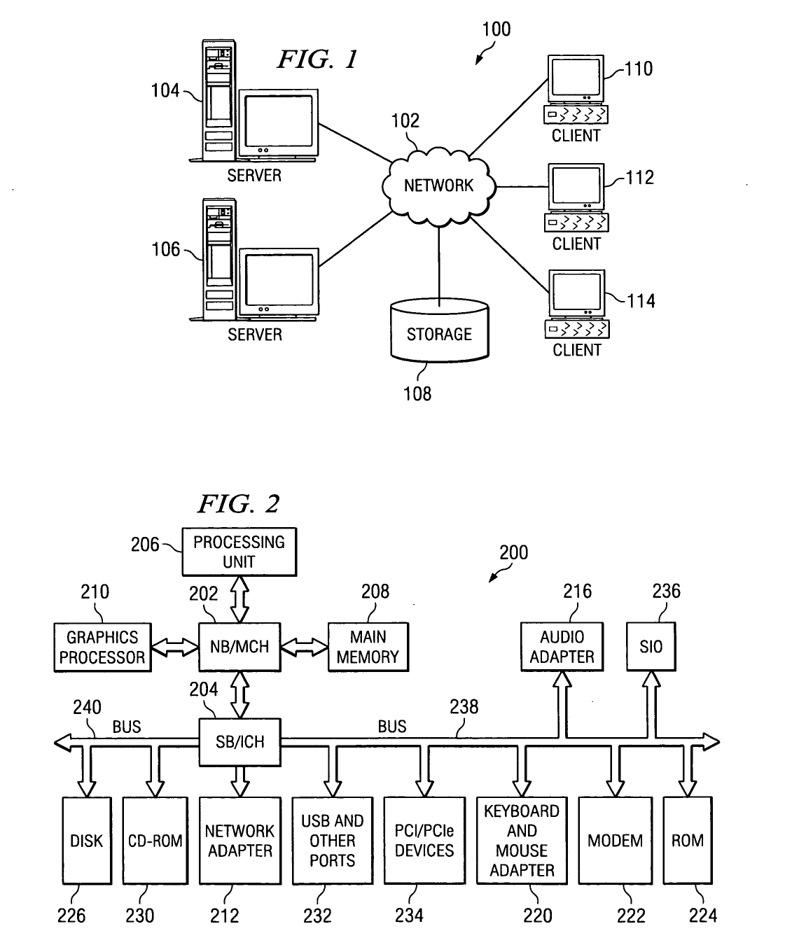

With reference now to the figures and in particular with reference to FIGS. 1-2, exemplary diagrams of data processing environments are provided in which illustrative embodiments may be implemented. It should be appreciated that FIGS. 1-2 are only exemplary and are not intended to assert or imply any limitation with regard to the environments in which different embodiments may be implemented. Many modifications to the depicted environments may be made.

With reference now to the figures, FIG. 1 depicts a pictorial representation of a network of data processing systems in which illustrative embodiments may be implemented. Network data processing system 100 is a network of computers in which embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. These clients 110, 112, and 114 may be, for example, personal computers, terminals, or network computers. In the depicted example, server 104 provides data, such as boot files, operating system images, and applications to clients 110, 112, and 114. Clients 110, 112, and 114 are clients to server 104 in this example. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for different embodiments.

With reference now to FIG. 2, a block diagram of a data processing system is shown in which illustrative embodiments may be implemented. Data processing system 200 is an example of a computer, such as server 104 or client 110 in FIG. 1, in which computer usable code or instructions implementing the processes may be located for the illustrative embodiments.

In the depicted example, data processing system 200 employs a hub architecture including a north bridge and memory controller hub (MCH) 202 and a south bridge and input/output (I/O) controller hub (ICH) 204. Processor 206, main memory 208, and graphics processor 210 are coupled to north bridge and memory controller hub 202. Graphics processor 210 may be coupled to the MCH through an accelerated graphics port (AGP), for example.

In the depicted example, local area network (LAN) adapter 212 is coupled to south bridge and I/O controller hub 204 and audio adapter 216, keyboard and mouse adapter 220, modem 222, read only memory (ROM) 224, universal serial bus (USB) ports and other communications ports 232, and PCI/PCIe devices 234 are coupled to south bridge and I/O controller hub 204 through bus 238, and hard disk drive (HDD) 226 and CD-ROM drive 230 are coupled to south bridge and I/O controller hub 204 through bus 240. PCI/PCIe devices may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM drive 230 may use, for example, an integrated drive electronics (IDE) or serial advanced technology attachment (SATA) interface. A super I/O (SIO) device 236 may be coupled to south bridge and I/O controller hub 204.

A hypervisor or operating system runs on processor 206 and coordinates and provides control of various components within data processing system 200 in FIG. 2. The hypervisor may be a commercially available hypervisor such as VMWare® Workstation or Xen™. The operating system may be a commercially available operating system such as Microsoft® Windows® XP (Microsoft and Windows are trademarks of Microsoft Corporation in the United States, other countries, or both). An object oriented programming system, such as the Java™ programming system, may run in conjunction with the operating system and provides calls to the operating system from Java programs or applications executing on data processing system 200 (Java and all Java-based trademarks are trademarks of Sun Microsystems, Inc. in the United States, other countries, or both).

Instructions for the operating system, the object-oriented programming system, and applications or programs are located on storage devices, such as hard disk drive 226, and may be loaded into main memory 208 for execution by processor 206. The processes of the illustrative embodiments may be performed by processor 206 using computer implemented instructions, which may be located in a memory such as, for example, main memory 208, read only memory 224, or in one or more peripheral devices.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may be comprised of one or more buses, such as a system bus, an I/O bus and a PCI bus. Of course the bus system may be implemented using any type of communications fabric or architecture that provides for a transfer of data between different components or devices attached to the fabric or architecture. A communications unit may include one or more devices used to transmit and receive data, such as a modem or a network adapter. A memory may be, for example, main memory 208 or a cache such as found in north bridge and memory controller hub 202. A processing unit may include one or more processors or CPUs. The depicted examples in FIGS. 1-2 and above-described examples are not meant to imply architectural limitations. For example, data processing system 200 also may be a tablet computer, laptop computer, or telephone device in addition to taking the form of a PDA.

The illustrative embodiments provide a computer implemented method, apparatus, and computer usable program code for a client outsourcing service for managing computers. The service uses virtual machine technology for computers. A virtual machine is a data processing system that appears to be at the exclusive disposal of a particular user but whose functions are accomplished by sharing the resources of a physical data processing system. The illustrative embodiments allow the user's personal computing environment to be saved and entirely contained within a virtual machine. The personal computing environment or computing environment is the personalized files and configuration information for using the personal computer. This computing environment includes, for example, applications, data, operating system, and other settings.

Virtual machine technology permits the accurate and complete capture of the state of a virtual machine and the corresponding state of a personal computing environment. This state can be transported to another personal computer so that the virtual machine behaves the same in the new personal computer as it did in the source personal computer. In effect, the virtual machine migrates from one physical machine to another based on the needs of the user. The virtual machine state may be saved and/or backed up to network storage or directly to another machine. The illustrative embodiments provide for an infrastructure, operational procedures, and a business model for providing PC-to-PC user mobility to an enterprise on an outsourced basis.

Thus, one aspect of the illustrative embodiments is a service that provides and manages an infrastructure wherein the user's personal computing environment is captured, transported, and restored. Another aspect of the illustrative embodiments is a set of operational procedures that are responsive to user commands and system events which cause the capture, transport, and restoration of the user's personal computing environment. Yet another aspect of the illustrative embodiments provides a mechanism for doing business with the aforementioned infrastructure and operational procedures.

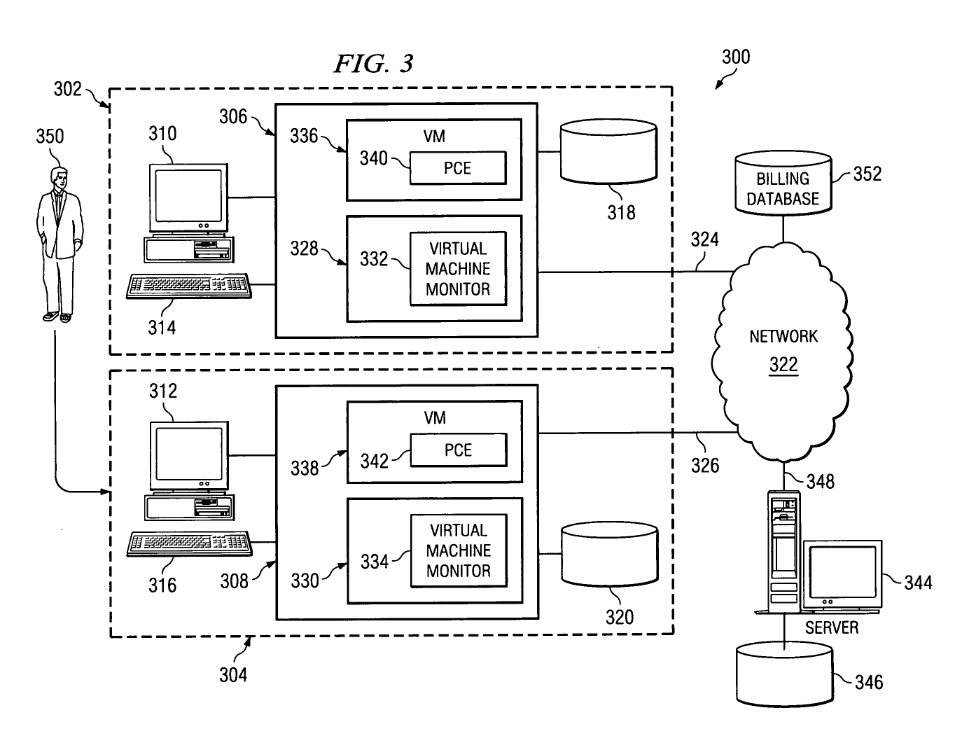

FIG. 3 is an exemplary infrastructure for client outsourcing services in accordance with the illustrative embodiments. Infrastructure 300 is one example of numerous configurations of client outsourcing service infrastructures or systems capable of supporting the client outsourcing services. Infrastructure 300 should not be construed as limited to the infrastructure configuration shown and discussed as an example.

In one illustrative embodiment, infrastructure 300 includes personal computers 302 and 304. Personal computers 302 and 304 are data processing systems, such as data processing system 200 of FIG. 2. Personal computers may be interconnected in a network data processing system, such as network data processing system 100 of FIG. 1. Personal computers 302 and 304 include system units 306 and 308, display devices 310 and 312, user input devices 314 and 316, and storage devices 318 and 320, respectively.

Personal computers 302 and 304 are connected to network 322 via communication links 324 and 326, respectively. Network 322 may be the Internet, public and private networks, including local area networks and wireless local area networks, and intranets. Communication links 324 and 326 may be any links known in the art for effecting communications including wired links, such as Ethernet links, wireless links, such as that standardized in IEEE 802.11b, or any other similar communications links.

Personal computers 302 and 304 run software 328 and 330, respectively. Software 328 and 330 include virtual machine monitor 332 and 334. For example, virtual machine monitor 332 and 334 may be a type 1 hypervisor, such as Xen™ running on the bare hardware, or a type 2 hypervisor, such as VMWare® Workstation software running on a general-purpose personal computer operating system, such as Linux®. Virtual machines 336 and 338 include end user personal computing environments or personal computing environments (PCE) 340 and 342. Virtual machines 336 and 338 hold the state of personal computing environments 340 and 342.

Personal computing environments 340 and 342 include the end user's personal computer operating system of choice. For example, the operating system may be the Windows® operating system, a product of the Microsoft Corporation of Redmond, Wash. Personal computing environments 340 and 342 also include data associated with the operating system. The associated data may represent the end user choices made during the installation and subsequent maintenance of that operating system, including all of the device driver software associated with that operating system. For example, in the example of the Windows® operating system, personal computing environments 340 and 342 includes the Windows® registry.

Personal computing environments 340 and 342 also includes all of the software and data associated with utility, entertainment, and productivity application programs, as selected and customized by the end user. Personal computing environments 340 and 342 also includes all of the data files that have been collected and created by the end user, including all data downloaded from the Internet, imported via any means, or created using the aforementioned utility, entertainment, and productivity application programs. In short, personal computing environments 340 and 342 are typical of the entire and complete software and data content of the typical personal computer with the exception of the Basic Input/Output System (BIOS) software.

FIG. 3 also shows server 344 with storage device 346 in which server 344 is also connected to network 322 via link 348. Server 344 may be a server, such as server 104 of FIG. 1. Billing database 352 is connected to network 322. Billing database 352 is a database used by a service provider to bill a customer for the use of infrastructure 300, including personal computers 302 and 304, server 344, and the ability to transfer multiple personal computing environments to other personal computers. The billing process is further described in FIG. 8.

End user 350 is shown currently using personal computer 302. The arrow proximate to end user 350 is intended to suggest the movement of end user 350 from a location near personal computer 302 to a different location near personal computer 304, illustrating end user 350 moving from using personal computer 302 to using personal computer 304.

In operation, end user 350 interacts with personal computer 302, and in the process, modifies and perhaps extends personal computing environment 340. Much of personal computing environment 340 resides in files on storage device 318. Preparatory to leaving personal computer 302, end user 350 invokes a command to virtual machine monitor 332 causing virtual machine 336 to stop and causing the entire personal computing environment 340 to be written to storage device 318, storage device 346, network 322, or some combination thereof.

Once virtual machine 336 is stopped, its state is easily moved to another physical machine via standard data transfer operations between storage devices. Such virtual machine migrations may be implemented by the virtual machine monitor itself or by a separate utility program. The destination physical machine may be manually specified by the user or automatically determined by the system. This can be done either reactively when the user appears at another location or proactively by learning user mobility patterns. The ability to migrate a personal computing environment from one physical machine to another is a key benefit of virtual machine technology.

The user may have open files and processes that are ongoing at the time that virtual machine 336 is placed in a suspended state as well as personal computing environment 340. The user is able to suspend use or go to a stand-by state for personal computing environment 340 to move locations. For example, end user 350 may want to move locations in order to ask a co-worker a question involved in a project. End user 350 may have a document open for editing and may be using an email application to send a status message.

End user 350 may then direct that personal computing environment 340 be stored on server 344 in preparation for the arrival of end user 350 at personal computer 304. Server 344 stores personal computing environment 340 on storage device 346. Upon the arrival of end user 350 at personal computer 304 or prior to that arrival, server 344 will copy personal computing environment 340 to personal computer 304, replacing personal computing environment 342 which currently resides there. After the copy is complete, end user 350 may begin using personal computer 304 with personal computing environment 340.

Personal computing environment 342 is a representation of personal computing environment 340 of end user 350 when used on personal computer 302. When end user 350 begins using personal computer 304, the entire personal computing experience is identical to that experienced with personal computer 302. The precise similarity may be subject to the availability of identical or similar hardware peripheral devices, such as display device 310 and user input device 314. The requirements of the hardware may not need to be identical if the performance is the same. For example, different monitors may have similar resolution and performance. End user 350 may resume processes and tasks that were being performed on personal computer 302 without losing time, effort, or reloading files and applications. As a result, virtual machine 336 is suspended along with personal computing environment 340 and may be completely migrated to personal computer 304.

For example, end user 350 may transfer personal computing environment 342 to personal computer 304 in order to continue editing a document and send an email message that was initiated on personal computer 302. In the new location, end user 350 may have resources or other users available that make working on personal computer 304 more desirable.

In another illustrative embodiment, the movement of personal computing environment 340 from personal computer 302 to personal computer 304 may occur directly, without the involvement of server 344. This illustrative embodiment may be advantageous if the communication bandwidth between personal computer 302 and personal computer 304 is substantially in excess of that available to either computer and to network 322. In all preferred embodiments, a current copy of personal computing environment 340 is backed up or saved on storage device 318, storage device 346, or another location in case personal computer 304 or server 344 has a total failure or if personal computing environment 340 is otherwise corrupted. Personal computing environment 340 may be backed up on a regular basis, before maintenance or repairs, or manually as selected by the user. As a result, the user may later restore a backed-up or archive copy of personal computing environment 340. The default setting is for the most recently saved copy of personal computing environment 340 to be restored for use unless the user selects otherwise. The participation of server 344 may be advantageous if, for example, personal computer 304 is not turned on when end user 350 leaves personal computer 302.

As an example of a service that may be provided with infrastructure 300, a service provider may contract with an enterprise customer to outsource the personal computers that are used within that enterprise. The provider may provide new personal computers to the enterprise or may retrofit infrastructure 300 onto the enterprise's existing personal computers.

The service provider agrees to manage the personal computers in such a way that enterprise personal computer users may use any personal computer with their own personal computing environment. The service provider provides client software, networking services, and servers that safely and efficiently allow the storage and transfer of personal computing environments to any of the enterprise personal computers.

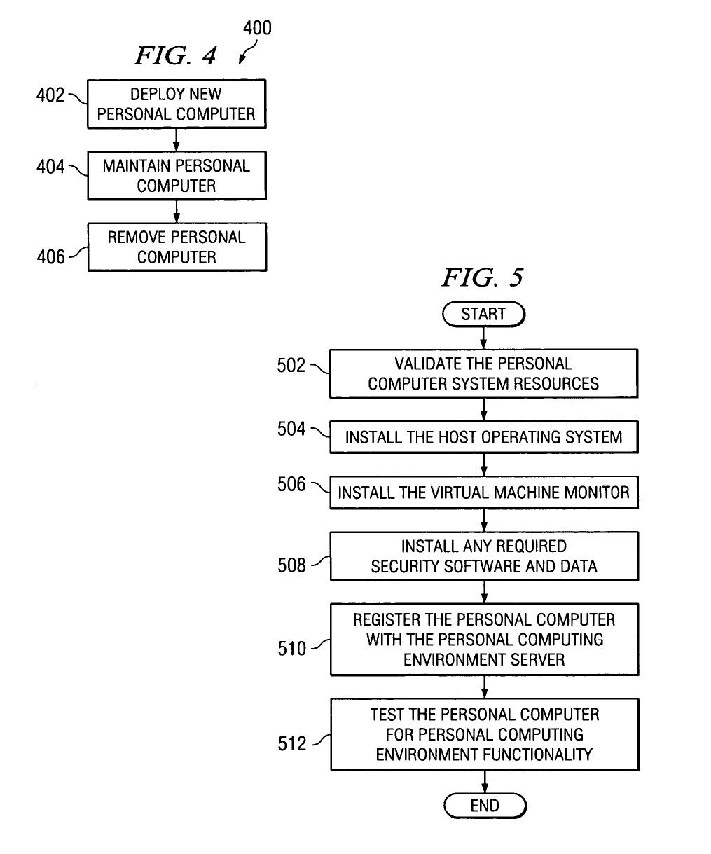

FIG. 4 is a lifecycle model of a personal computer in accordance with the illustrative embodiments. Lifecycle 400 illustrates the entire lifecycle of a personal computer, such as personal computers 302 and 304 of FIG. 3. The lifecycle may begin in response to the enterprise customer communicating the need for a new personal computer to the service provider, including electronic or physical communications. For example, the enterprise customer may email the service provider a request for a new personal computer for a new hire. The service provider then deploys the new personal computer (step 402). The details of step 402 are further described in FIG. 5.

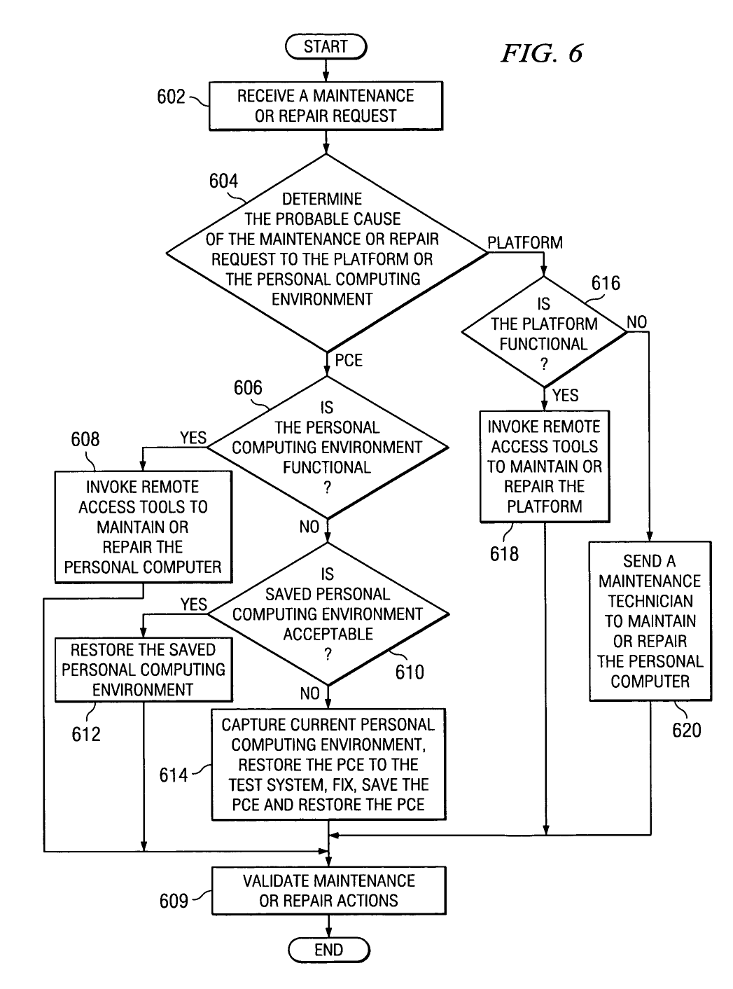

After the personal computer has been deployed according to the terms of service, the service provider will periodically or on demand maintain the personal computer (step 404). Step 404 is typically defined by the service contract. Typically, personal computer maintenance includes preventative maintenance and remedial maintenance. During preventative maintenance, the hardware and software of the personal computer are serviced and updated so as to sustain responsive and correct operation. During remedial maintenance, the hardware and software of the personal computer is fixed to eliminate conditions of inoperability. The personal computer is typically fixed in accordance with the service agreement or terms of service. The service agreement is a contract specifying the required actions of the user or client and the service provider including terms, requirements, services provided, and expenses. The details of step 404 are further described in FIG. 6.

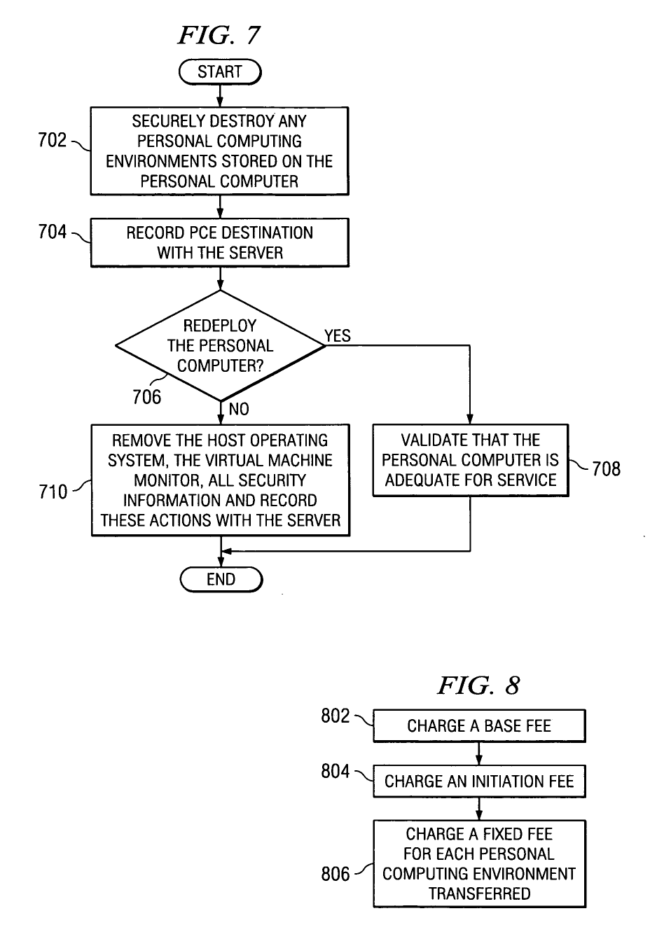

At the end of a personal computer's lifecycle, again responsive to communication from the enterprise customer, the service provider removes the personal computer (step 406). The details of step 406 are further described in FIG. 7. The terms of the removal process of step 406 are also defined in the service contract and include the removal of the personal computer hardware, the secure destruction of any personal computing environment currently stored in whole or in part on the storage devices of the personal computer, and the removal of other software. Step 406 will also be described in detail subsequently.

The process of FIG. 4 may be distinguished from currently used personal computer lifecycle management services based on infrastructure 300 of FIG. 3. In particular, the process of FIG. 4 may be applied to a method that allows a user to access a personal computing environment that may be moved and executed on distinct personal computers. The process is distinguished in FIGS. 5-7.

FIG. 5 is a flowchart of a process for deploying a new personal computer in accordance with the illustrative embodiments. The process of FIG. 5 may be implemented by a service provided in a computer infrastructure, such as infrastructure 300 of FIG. 3. The process of FIG. 5 is a more detailed explanation of step 402 of FIG. 4. The process begins validating the personal computer system resources (step 502). The personal computer may be a personal computer, such as personal computers 302 and 304 of FIG. 3.

In step 502, the specifications of the new personal computer hardware, such as processor speed, memory, storage, and network bandwidth as well as BIOS are validated to ensure the resources are adequate for the provision of the service. Step 502 is required because the configuration of personal computer software required for service provision may be more resource-intensive than for personal computers not participating in the service.

Next, the service provider installs the host operating system (step 504) and installs the virtual machine monitor (step 506). In steps 504 and 506, the unique infrastructure required by the service is installed including device drivers, management agents, and any custom utilities required by the service provider. The infrastructure includes a virtual machine monitor, such as virtual machine monitor 332 of FIG. 3 which, in turn, may or may not require a host operating system. Since this unique infrastructure deals directly with the personal computer hardware and BIOS, it will require specific device drivers for the various devices attached to the personal computer. Preferably, the unique infrastructure also includes manageability software intended so that the service provider may efficiently and effectively manage the unique infrastructure and the hardware and BIOS of the personal computer. As an example, this manageability software should field events from BIOS and device drivers concerning impending management issues.

Next, the service provider installs the required security software and data (step 508). The security software and data of step 508 is the information required to perform the service installed. For example, the software and data may preferably provide a “trusted computing platform” or security safeguards that prevent misuse of the personal computer.

Next, the service provider registers the personal computer with the personal computing environment server (step 510). The personal computing environment server is a server that may be used to store personal computing environments, such as server 344 of FIG. 3. The method of registration is preferably electronic. For example, the server records the registration in a database or storage device, such as storage device 346 of FIG. 3

Server registration as shown in step 510, permits the server to identify the personal computer as a source or destination of personal computing environments. The server registration also indicates that software licenses for software installed in steps 504-508 are now in use. Next, the service provider tests the personal computer for personal computing environment functionality (step 512). In step 512, the service provider validates the entire process of initial deployment by causing the server to copy a test personal computing environment to the personal computer. This test personal computing environment is preferably designed to fully exercise the personal computer in an automatic manner so as to increase the confidence that the personal computer is ready to support the service.

For example, when a new personal computer has gone through the process of FIG. 5, a personal computing environment, such as personal computing environment 340 of FIG. 3, may be downloaded or transferred and fully executed to ensure functionality of the personal computing environment on the new personal computer. The process terminates after step 512 has been successfully performed.

FIG. 6 is a flowchart of a process for maintaining a personal computer in accordance with the illustrative embodiments. The process of FIG. 6 may be implemented by a service provided in a computer infrastructure, such as infrastructure 300 of FIG. 3. The process of FIG. 6 is a more detailed explanation of step 404 of FIG. 4. The process of FIG. 6 begins when the service provider receives a maintenance or repair request for the personal computer (step 602). The request is an event indicating the need to maintain or repair the personal computer. The request may originate as a telephone call, email, notification from the operating system or virtual machine monitor software, or as a time-triggered event. The request may be delivered by manual or electronic means, such as postal mail or email.

The request may originate from the management agent on the host operating system or virtual machine monitor, from the management agent on the guest operating system, or from any other utility or application software capable of generating such events.

Next, the service provider determines the probable cause of the maintenance or repair request to the platform or the personal computing environment (step 604). In step 604, the service provider isolates the probable cause of the request to either the platform including personal computer hardware, BIOS, host operating system and virtual machine monitor or to a personal computing environment. The isolation may be effected from the source of the request using any number of currently used systems and methods. For example, if the request originates from a management agent in the personal computing environment, that scenario strongly indicates that the probable cause is within the personal computing environment.

If the service provider determines the personal computing environment is the probable cause of the request, the service provider determines if the personal computing environment is functional (step 606). The personal computing environment is functional if it is capable of running such software as is necessary to fix it remotely. If the personal computing environment is functional, the service provider invokes remote access tools to maintain or repair the personal computer (step 608). Next, the service provider validates the maintenance or repair actions (step 609) with the process terminating thereafter. The validation of step 609 may be observed, validated, and verified in various ways including: proper functioning of the various management agents, telephone conversations, instant messaging or email conversations with the personal computer user through exercising the platform and/or personal computing environment via remote console takeover, or through any other validation techniques.

Remote maintenance used for maintenance and repair of personal computing environments in step 608 may involve currently used methods and practices. For example, repair and maintenance methods may include remote console takeover in which a remote service technician gains control over the logical user input devices and gains access to the logical display of the personal computer.

If the personal computing environment is not functional in step 606, the service provider determines if the saved personal computing environment is acceptable (step 610). During step 610, the current personal computing environment user is queried to determine whether a prior copy of the personal computing environment, created when the personal computing environment was last saved, is acceptable. For example, if the service provider had initiated preventative maintenance, resulting in a nonfunctional personal computing environment, the saved personal computing environment should be acceptable.

If the saved personal computing environment is acceptable, the service provider restores the saved personal computing environment (step 612) after which the service provider validates the maintenance or repair actions (step 609) with the process terminating thereafter. If the saved personal computing environment is not acceptable in step 610, the service provider captures the current personal computing environment (PCE), restores the PCE to the test system, fixes the PCE, saves the PCE, and restores the PCE (step 614) after which the service provider validates the maintenance or repair actions (step 609) with the process terminating thereafter.

For example, if the current user of the personal computing environment has significantly altered the personal computing environment since the last save, the prior copy may not be acceptable in step 610. In step 614, a service technician may save the current personal computing environment, copy the personal computing environment to a test personal computer, and work with the personal computing environment to try to determine why it has failed and how to fix it. The diagnostic and remediation procedures of step 614 are similar to those currently performed by service technicians except that the service technician does not have to travel to the personal computer on which the problem originated. Once the problem with the personal computing environment has been fixed, the service technician may then save the personal computing environment and restore the personal computing environment to the personal computer on which the problem originated.

Turning back to step 604, if the service provider determines the platform is the probable cause of the request, the service provider determines if the platform is functional (step 616). In step 616, the remote service technician determines whether the platform is capable of running software necessary to fix the platform remotely. If the platform is functional, the service provider invokes remote access tools to maintain or repair the platform (step 618) after which the service provider validates the maintenance or repair actions (step 609) with the process terminating thereafter. If the platform is not functional in step 616, the service provider sends a maintenance technician to maintain or repair the personal computer (step 620) after which the service provider validates the maintenance or repair actions (step 609) with the process terminating thereafter.

FIG. 7 is a flowchart of a process for removing a personal computer in accordance with the illustrative embodiments. The process of FIG. 7 may be implemented by a service provided in a computer infrastructure, such as infrastructure 300 of FIG. 3. The process of FIG. 7 is a more detailed explanation of step 406 of FIG. 4.

The process of FIG. 7 details the unique steps required to remove a personal computer. The process begins with the service provider first securely destroying any personal computing environments stored on the personal computer (step 702). In step 702, any personal computing environments currently cached or otherwise residing on the personal computer selected for removal are securely destroyed. The process of secure destruction may include the secure erasure of any files associated with the personal computing environment.

During step 702, files may be overwritten with random data multiple times.

Next, the service provider records the personal computing environment destination with the server (step 704). The server may be a server, such as server 344 of FIG. 3. Step 704 ensures that the server does not assume the presence of any of the personal computing environments on the personal computer selected for removal.

Next, the service provider determines if the personal computer is going to be redeployed (step 706). The service provider may determine whether to redeploy the personal computer based on condition, customer needs, required service, and technical requirements. If the personal computer is to be redeployed as part of a given service, the process validates that the personal computer is adequate for the service (step 708) with the process terminating thereafter. Step 708 may be similar to step 512 of FIG. 5 in which the personal computer is tested to verify personal computing environment functionality and overall fitness for service.

If the personal computer is not to be redeployed in step 706, the service provider removes the host operating system, the virtual machine monitor, all security information, and records these actions with the server (step 710) with the process terminating thereafter. In step 710, all of the software and data that constitute the platform are removed and the server is notified. Server notification is required so that any attempts to restore a personal computing environment to the personal computer are rejected in the future and any software licenses associated with the platform will be marked as not in current use.

FIG. 8 is a flowchart for a possible billing process in accordance with the illustrative embodiments. The provider of the client outsourcing service may apply a variety of billing models to charge for different aspects of the service. FIG. 8 is one example. The billing model specifies when, why, and how much the client is charged for billable actions and services. For example, billable actions may include initial setup, repairs, monthly service charges, the number of personal computing environments that migrate each month, potential service for a number of computing devices, and other similar charges per time, usage, or event. The billing process of FIG. 8 may be implemented by a billing database, such as billing database 352 of FIG. 3.

Service providers of the service described herein may practice a range of business models. All of the fee steps as referenced in FIG. 8 may not be used or may be used in a different combination, adding and removing fee steps for the user's needs. The service provider charges a base fee (step 802). The base fee for the service may be a fixed fee or a per-seat fee scaled according to the number of personal computers supported or for a fee scaled by the number of personal computing environments supported.

The base fee may cover the installation, repair and maintenance, and removal of personal computers such as the steps of FIG. 4. The base fee may cover the hardware, including personal computers and servers, as well as replacement parts. The base fee may also cover salaries and contracts for service and repair of the infrastructure. The base fee of step 802 may also be a monthly fee for each personal computer supported by the service. The base fee may be increased if there are more personal computing environments than personal computers. Other charging models may also be used. The base fee may also be based on usage of the computers or personal computing environment transfer.

Next, the service provider charges an initiation fee (step 804). For example, the initiation fee may be a fixed fee for initiating the service. In another example, the initiation fee may be for adding new personal computers, such as personal computer 302 to an infrastructure, such as infrastructure 300 both of FIG. 3.

Next, the service provider charges a fixed fee for each personal computing environment transferred (step 806). For example, every time a personal computing environment is captured, stored, and restored, the service provider may charge a fixed fee or transfer fee. In an alternative process, the base fee of step 802 may cover as many transfers as are performed by the user. The transfer fee of step 806, may also include a fee for transporting and storing the personal computing environment and for network use and/or bandwidth used during personal computing environment transport.

For example, fees may be charged for the storage device space required for personal computing environments. Since the storage for a given personal computing environment may vary from that required for other personal computing environments, a space-based charging model reflects resource consumption better than a charging model based only on the number of personal computing environments stored.

The service provider may encourage the storage of personal computing environments captured prior to the capture of the current personal computing environment for a given user. Storing the personal computing environment increases storage resource consumption for personal computing environments but may reduce the service cost. If a prior personal computing environment is not stored, more labor may be required to fix the current personal computing environment. If a prior personal computing environment is stored, there will be times when that personal computing environment is acceptable to the end user, obviating the need to fix the current personal computing environment.

Thus, the illustrative embodiments provide a client outsourcing service for managing personal computers. The illustrative embodiments allow the user's personal computing environment to be saved entirely within a virtual machine. The personal computing environment may be transported to another personal computer so that the new personal computer looks and behaves the same as the source personal computer. The personal computing environment may be saved and/or backed up to network storage or directly to another machine. The illustrative embodiments provide for an infrastructure, operational procedures, and a business model for providing PC-to-PC user mobility to an enterprise on an outsourced basis. As a result, a user does not need to carry around a mobile computer or use complex network solutions in order to access a personal computing environment at all times.

It is to be appreciated that many business models may be used in conjunction with the service described herein. Business models may include, but are not limited to, the participation of third parties, such as storage service providers, help desk service providers, on-site maintenance service providers, remote service providers, and other similar services.

The foregoing description of the illustrative embodiments has been presented for purposes of illustration and description. It is not intended to be exhaustive or to limit the invention to the precise form disclosed, and other modifications and variations may be possible in light of the above teachings. It may be seen that the description given above provides a simple but complete implementation of a client outsourcing service. The illustrative embodiments allow a service provider to implement and operate an infrastructure so as to provide mobility of personal computing environments. This mobility may be limited to a given geographic region between or among multiple geographic regions or unlimited in geographic extent.

The embodiments described herein enable many forms of service and many business models for the provision of services. The providers of services may be single entities, multiple entities divided by functional scope, or multiple entities divided by geographic coverage. The purposes for the service are various, including but not limited to, personal computing environment mobility, personal computing environment backup, and multiple personal computing environments per end user. Although the term ‘personal computing environment’ has been used here, it may be appreciated that the service as described manages computing environments which may be computing environments on personal computers or on servers. Thus, a server computing environment, for the provision of a website, may run in a virtual machine. The service described herein may be used to replicate or transport this server computing environment to another or several servers for purposes of recovery, geographic advantage, or to increase the total server resources available to a given website.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method for managing computers, the method comprising:
responsive to forming a contractual agreement to provide outsourcing management of computers, deploying computers on a network for use by users, wherein the computers include virtual machines, and wherein a computing environment of a user is accessible on a first computer using a virtual machine located on the first computer; and
maintaining the virtual machines on the computers, wherein a virtual machine state may be transferred from the first computer to a second computer, wherein the second computer runs the virtual machine, and wherein the computing environment is accessible to the user on the second computer.

2. The method of claim 1, further comprising:
responsive to a user request to remove the first computer, removing the first computer from the network.

3. The method of claim 1, wherein the user specifies the second computer.

4. The method of claim 1, wherein the user selects the second computer by logging in to the second computer.

5. The method of claim 1, further comprising:
retrofitting the computers with virtual machines for allowing the computing environment to migrate between the computers.

6. The method of claim 1, wherein the deploying, and maintaining steps are performed remotely.

7. The method of claim 1, wherein the deploying and, maintaining steps are performed by a service provider according to terms of service, wherein the maintaining step further comprises:
maintaining hardware and software of the computers.

8. The method of claim 1, wherein the terms of service specify periodic or on-demand performance.

9. The method of claim 1, wherein the deploying step further comprises:
validating the computers to ensure hardware and software of each of the computers are adequate for allowing a plurality of computing environments to migrate between the computers.

10. The method of claim 9, wherein the deploying step further comprises:
installing software on the computers for allowing the plurality of computing environments to migrate between the computers; and
testing the software on the computers for ensuring an ability of the plurality of computing environments to migrate between the computers.

11. The method of claim 1, further comprising:
charging a base fee for deploying and maintaining the computers.

12. The method of claim 1, wherein the base fee is based on any of a fixed fee, per-seat fee, usage-based fee, and fee for a number of computing environments.

13. The method of claim 1, further comprising:
charging an initiation fee; and
charging a transfer fee.

14. The method of claim 1, further comprising:
responsive to a user request, capturing the virtual machine state within the first virtual machine executing on the first computer to form a captured state;
saving the captured state to a server;
responsive to the user accessing the second computer, transferring the captured state to the second computer; and
restoring the virtual machine state for executing the computing environment using the second virtual machine on the second computer, wherein the computing environment restored on the second computer is accessed directly by the user.

15. A data processing system for managing computers comprising:
a server for storing a plurality of computing environments for use by the computers;
a billing database operably connected to the server for recording billable actions;
a plurality of clients operably connected to the server by a network including at least a first client and a second client; and
wherein a user may access the first client, wherein the first client includes a virtual machine containing a computing environment, wherein a virtual machine state of the virtual machine is completely transferred to the second client based on user input, wherein the user may access the computing environment from the second client, and wherein the billable actions are recorded on the billing database based on ongoing deployment, maintenance, and removal of each of the computers.

16. The system of claim 15, further comprising a storage device operably connected to the server or the first client for saving a copy of the computing environment.

17. The system of claim 16, wherein the copy is a back-up in case a captured version of the computing environment fails, wherein the back-up may be selected from a number of backups based on needs of the user.

18. A computer program product comprising a computer usable medium including computer usable program code for managing computers, the computer program product comprising:
computer usable program code responsive to contracting to forming a contractual agreement to provide outsourcing management of computers, for deploying computers on a network for use by users, wherein the computers include virtual machines, and wherein a computing environment is accessible on a first computer using a virtual machine located on the first computer; and
computer usable program code for maintaining the virtual machines on the computers, wherein a virtual machine state may be transferred from the first computer to a second computer, wherein the second computer runs the virtual machine, and wherein the computing environment is accessible to the user on the second computer.

19. The computer program product of claim 18, further comprising:
computer usable program code for retrofitting the computers for allowing the computing environment to migrate between the computers;
computer usable program code for validating the computers to ensure hardware and software of each of the computers is adequate for allowing a plurality of computing environments to migrate between the computers;
computer usable program code for installing software on the computers for allowing the plurality of computing environments to migrate between the computers;
computer usable program code for testing the software on the computers for ensuring an ability of the plurality of computing environments to migrate between the computers;
computer usable program code for charging a client based on a service agreement; and
computer usable program code for removing each of the computers from the network based on user input.

20. The computer program product of claim 18, further comprising:
computer usable program code responsive to a user request, for capturing the virtual machine state within the first virtual machine executing on the first computer to form a captured state;
computer usable program code for saving the captured state to a server;
computer usable program code responsive to the user accessing the second computer, for transferring the captured state to the second computer; and
computer usable program code for restoring the virtual machine state for executing the computing environment using the virtual machine on the second computer, wherein the computing environment is accessible on the second computer.
